(19) United States
(12) Patent Application Publication
(10) Pub. No.: US 2026/0205506 A1
(43) Pub. Date: Jul. 16, 2026

(54) TECHNIQUES FOR REAL-TIME PREDICTING OF MEDIA CONTENT

(71) Applicant: HARMAN BECKER AUTOMOTIVE SYSTEMS GmbH, Karlsbad-Ittersbach (DE)

(72) Inventor: Sachin NAYAK, Karnataka (IN)

(21) Appl. No.: 19/022,405

(22) Filed: Jan. 15, 2025

(51) Int. Cl. H04L 65/61; H04L 65/80

(52) U.S. Cl. CPC H04L 65/61; H04L 65/80

(57) ABSTRACT

The disclosed techniques compensate for buffer underruns by predicting missing media content. During playback of a stream of media content, a client device receives data packets. A packet predicting system (PPS) of the client device includes two buffers. The first buffer in the packet predicting system is a buffer that temporarily stores the data packets. The second buffer, also in the PPS, is a buffer that stores copies of the data packets stored in the first buffer. In addition, the PPS predicts a predetermined number of future packets each time new data packets are copied to the second buffer. When a client application of the client device requests the next packet, the PPS provides the next packet from the first buffer to a buffer located in the client application. However, when the first buffer is empty, the PPS provides a predicted packet from the second buffer to the client application.

### BACKGROUND

### Field of the Various Embodiments

The various embodiments relate generally to real-time streaming of media content and, more specifically, to techniques for real-time predicting of media content.

### Description of the Related Art

Computer networks are becoming integral to more systems, such as automotive systems, due to the vast capabilities available, such as high bandwidth, real-time streaming support, autonomous driving, infotainment, and other diverse applications. Real-time streaming protocols, such as the Audio Video Transport Protocol (AVTP), can be used to address the unique requirements of streaming media content over computer networks, such as low latency, synchronization, and quality of service considerations. However, real-time streaming protocols can experience technical challenges related to network congestion and packet loss. Specifically, buffer underruns can occur during network congestion. Buffer underruns occur when the receiving device does not receive data from the transmitting device quickly enough, which can lead to interruptions, gaps, or dropouts in the media content stream.

One approach to correcting buffer underruns is rate control. Rate control is the process of the transmitting device adjusting the transmission rate to match the capabilities of the receiving device. Another approach to correcting buffer underruns is flow control. Flow control is the process of the receiving device signaling to the transmitting device that the receiving device is ready to receive more data. The transmitting device would then need to receive the signal and determine that more data can be sent.

One drawback of rate control and flow control is that both require the transmitting device to perform additional steps during the real-time streaming process. Both adjusting the transmission rate to match the capabilities of the receiving device and listening for additional signals to determine the receiving device is ready for more data incur a resource and time loss to the system. Additionally, not every transmitting device is capable of performing rate control and flow control optimally.

As the foregoing illustrates, what is needed in the art is more effective techniques for addressing buffer underruns during real-time streaming of media content.

### SUMMARY

In various embodiments, a computer-implemented method for handling media data comprises receiving a first data packet from a streaming data interface, the first data packet including media data; storing the first data packet to a first buffer; storing the first data packet to a second buffer; generating, based on one or more data packets stored in the second buffer, a first predicted data packet; storing, in the second buffer, the first predicted data packet; and in response to determining that a second data packet should be provided, providing the second data packet from the first buffer or the second buffer, wherein the second data packet is usable by the client application as output streamed to a user. Further embodiments include systems and non-transitory computer-readable media that perform the steps of the methods disclosed herein.

At least one technical advantage of the disclosed techniques relative to the prior art is that the disclosed techniques allow for the receiving device to automatically compensate for buffer underruns by using corrective measures solely at the receiving device. This reduces the computational burden on the transmitting device to perform additional processes, such as rate control or flow control. In addition, this reduces network bandwidth as rate control and flow control messages do not need to be exchanged between the receiving and transmitting devices. Furthermore, the disclosed techniques predict missing data packets before the receiving device misses one or more data packets due to a buffer underrun, or other network congestion. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a computer system configured to implement one or more aspects of the various embodiments;

FIG. 2 is a conceptual illustration of another computer system, according to various embodiments;

FIG. 3 is a conceptual illustration of an exemplary snapshot in time of various buffers and the contents of the various buffers, according to various embodiments;

FIG. 4 is another conceptual illustration of another exemplary snapshot in time of various buffers and the contents of the various buffers, according to various embodiments;

FIG. 5 is another conceptual illustration of another exemplary snapshot in time of various buffers and the contents of the various buffers, according to various embodiments;

FIG. 6 is another conceptual illustration of another exemplary snapshot in time of various buffers and the contents of the various buffers, according to various embodiments;

FIG. 7 is another conceptual illustration of another exemplary snapshot in time of various buffers and the contents of the various buffers, according to various embodiments;

FIG. 8 is flowchart of method steps for compensating for buffer underruns by predicting missing audio and/or video data, according to various embodiments; and

FIG. 9 is another flowchart of method steps for compensating for buffer underruns by predicting missing audio and/or video data, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

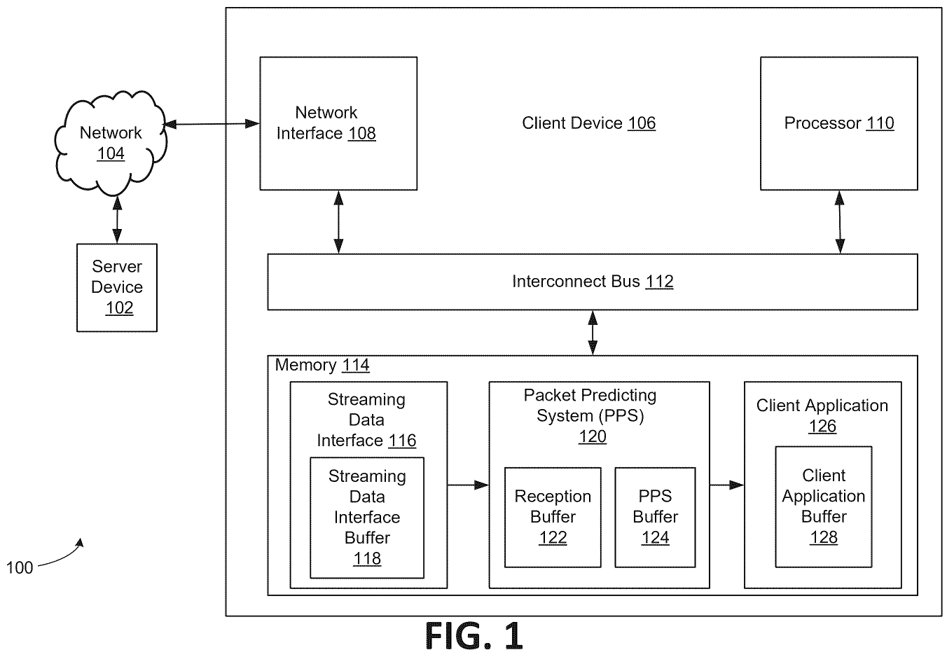

FIG. 1 illustrates a block diagram of a computer system 100 configured to implement one or more aspects of the various embodiments. As shown, system 100 includes, without limitation, a server device 102, a network 104, and a client device 106. As shown, client device 106 includes, without limitation, a network interface 108, a processor 110, an interconnect bus 112, and a memory 114. As shown, memory 114 includes, without limitation, a streaming data interface 116, a packet predicting system (PPS) 120, and a client application 126. As shown, streaming data interface 116 includes, without limitation, a streaming data interface buffer 118. As shown, PPS 120 includes, without limitation, a reception buffer 122 and a PPS buffer 124. As shown, client application 126 includes, without limitation, a client application buffer 128.

System 100 is shown herein for illustrative purposes only, and variations and modifications are possible without departing from the scope of the present disclosure. For example, system 100 can include multiple instances of elements, such as multiple server devices, and/or the client devices, even when not shown, and still be within the scope of the disclosed embodiments. Further, the connection topology between the various units in FIG. 1 can be modified as desired. In some embodiments, any combination of the server and/or client devices can be included in and/or replaced with any type of virtual computing system, distributed computing system, and/or cloud computing environment, such as a public, private, or a hybrid cloud system.

Server device 102 is configured to transmit media content over a network, such as network 104. The media content can be in any technically feasible form of data packets, without limitation, such as audio, video, text, image, and/or animation data packets. Server device 102 can include a web server, database, and/or server application configured to facilitate communication of media content with client device 106 via network 104. In some embodiments, server device 102 can be a content distribution network (CDN) including various server devices to facilitate the communication of media content.

Network 104 includes a plurality of network communications systems, such as routers and switches, configured to facilitate data communication between server device 102, client device 106, and/or other external devices. Persons skilled in the art will recognize that many technically feasible techniques exist for building network 104, including technologies practiced in deploying an Internet communications network. For example, network 104 can include a wide-area network (WAN), a local-area network (LAN), and/or a wireless (Wi-Fi) network, among others. Various protocols, such as the Audio Video Transport Protocol (AVTP), can be used in conjunction with network 104 to facilitate the transfer of media content (e.g., audio, video, text, image, and/or animation data) between devices connected to network 104.

Client device 106 is a media content processing device, such as a home theater system, sound system, vehicle audio system, and similar system/device. For example, client device 106 can be included in one or more devices, such as consumer products (e.g., portable speakers, gaming, etc. products), vehicles (e.g., the head unit of a car, truck, van, etc.), smart home devices (e.g., smart lighting systems, security systems, digital assistants, etc.), communications systems (e.g., conference call systems, video conferencing systems, speaker amplification systems, etc.), mobile devices (e.g., smart phones, tablets, etc.), entertainment systems (e.g., stadiums, concerts, airports, public buildings, etc.), network devices (e.g., switch, router, modem, etc.), computers, and so forth. In various embodiments, client device 106 is located in various acoustic environments including, without limitation, vehicles, indoor environments (e.g., living room, conference room, conference hall, home office, etc.), and/or outdoor environments, (e.g., patio, rooftop, garden, etc.).

Network interface 108 is configured to transmit and receive packets of data to and from server devices, such as server device 102, via network 104. In some embodiments, network interface 108 is configured to communicate using any technically feasible networking standard, such as the well-known Ethernet standard. Network interface 108 communicates with processor 110 and memory 114 via interconnect bus 112.

Processor 110 is configured to read from and write data to memory 114. Processor 110 is configured to retrieve and execute programming instructions, such as streaming data interface 116, PPS 120, and client application 126, stored in memory 114. Similarly, processor 110 is configured to store application data (e.g., software libraries) and retrieve application data from memory 114. Processor 110 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of processing units, such as a CPU configured to operate in conjunction with a GPU. In general, processor 110 can be any technically feasible hardware unit capable of processing data and/or executing software applications.

Interconnect bus 112 is configured to facilitate transmission of data, such as programming instructions, application data, media content, such as audio, video, text, image, and/or animation data, and other data, between network interface 108, processor 110, memory 114, and any other components of client device 106. Other aspects of client device 106 not shown can also communicate with each other aspect of client device 106 using interconnect bus 112.

Memory 114 can include a random-access memory (RAM) module, a flash memory unit, or any other type of memory unit or combination thereof. In various embodiments, memory 114 includes non-volatile memory, such as optical drives, magnetic drives, flash drives, or other storage. In some embodiments, separate data stores, such as an external included in the network 104 (“cloud storage”) can supplement the memory 114. Streaming data interface 116, PPS 120, and client application 126 within memory 114 can be executed by processor 110 to implement the overall functionality of the client device 106 and, thus, to coordinate the operation of the system 100 as a whole.

Streaming data interface 116 is configured to receive data packets from network interface 108. In some embodiments, the data packets can be associated with a media content stream. Streaming data interface 116 is configured to detect when a next data packet is needed. In some embodiments, streaming data interface 116 receives data packets from network interface 108 in response to a request for data packets. In some embodiments, streaming data interface 116 receives data packets from network interface 108 based on a regular interval, such as 5 milliseconds (ms). For example, streaming data interface 116 can receive a start instruction, or similar instruction, from PPS 120, indicating to start receiving packets from network interface 108 and start sending packets to PPS 120 at a regular interval, such as 5 ms. Streaming data interface 116 is configured to send data packets to PPS 120 based on the determining the predetermined amount of time associated with the regular interval has lapsed. For example, Streaming data interface 116 can determine that a time of 5 ms has lapsed since sending a data packet. Streaming data interface 116 can send a next data packet to PPS 120 based on the lapse of 5 ms. In some embodiments, streaming data interface 116 can store an initial group of data packets, such as 5, 10, 15, 20 or any other number of data packets, in streaming data interface buffer 118 prior to sending a first data packet to PPS 120. Streaming data interface 116 can be located in the physical layer or data-link layer of the Open System Interconnection (OSI) model. In some embodiments, streaming data interface 116 can be located in network access layer or network layer of the Transmission Control Protocol/Internet Protocol (TCP/IP) model. In some embodiments, streaming data interface 116 is located in a layer of the OSI model or TCP/IP model that is below a layer in which PPS 120 and/or client application 126 are located. In some embodiments, streaming data interface 116 is located in the same layer of the OSI model or TCP/IP model as a layer in which PPS 120 and/or client application 126 are located. Streaming data interface 116 includes streaming data interface buffer 118. When the streaming data interface 116 receives a data packet, streaming data interface 116 stores (e.g., pushes) the data packet in streaming data interface buffer 118. In some embodiments, each data packet has a sequence number associated with it. The sequence number identifies where in the data stream the data packet appears. Upon request from another module, such as PPS 120, streaming data interface 116 retrieves (e.g., pops) a data packet from streaming data interface buffer 118 and provides the retrieved data packet to the requesting module. If the streaming data interface buffer 118 is empty, streaming data interface 116 notifies the requesting module that no data packets are available.

Streaming data interface buffer 118 is a first-in first-out (FIFO) buffer. Streaming data interface buffer 118 can be implemented, without limitation, as a single buffer, double buffer, circular buffer, array buffer, ring buffer, vertex buffer, constant buffer, or any other technically feasible type of buffer. In some embodiments, streaming data interface buffer 118 includes a write pointer and read pointer (not shown) that reference locations in the memory of streaming data interface buffer 118 where one or more data packets are stored. When a data packet is written (e.g., pushed) to the streaming data interface buffer 118, the data packet is stored at a next available location. When a data packet is read (e.g., popped) from streaming data interface buffer 118 by streaming data interface 116, streaming data interface buffer 118 retrieves the oldest data packet from memory and provides the data packet to streaming data interface 116. When streaming data interface buffer 118 does not have a data packet that can be read, streaming data interface buffer 118 indicates that streaming data interface buffer 118 is empty.

PPS 120 is configured to receive data packets from streaming data interface. In some embodiments, the data packets can be associated with a media content stream, such as an audio, video, text, image and/or animation data stream. PPS 120 can be located in the data link layer or network layer of the OSI model or network layer of the TCP/IP model. In some embodiments, PPS 120 is located in a layer of the OSI model or TCP/IP model that is below the layer in which client application 126 is located and above which streaming data interface 116 is located. In some embodiments PPS 120 is located in the same layer of the OSI model or TCP/IP model in which client application 126 is located. In some embodiments, PPS 120 is located in the same layer of the OSI model or TCP/IP model in which streaming data interface 116 is located.

When PPS 120 receives data packets from streaming data interface 116, PPS 120 first stores the received packet in reception buffer 122. PPS 120 also stores a copy of the received packet in PPS buffer 124.

PPS 120 is further configured to predict future data packets based on the data packets stored in PPS buffer 124. In some embodiments, PPS 120 uses a machine learning model to predict future data packets based on previously stored data packets. In order to support multiple media content formats, PPS 120 selects a machine learning model to perform the prediction based on the format of the data packets. The machine learning model can be selected from a pool of available machine learning models. For example, a machine learning model trained to predict video data packets can be used by PPS 120 if the data packets received by PPS 120 are defined by a video format, such Moving Picture Experts Group 4 part 14 (MPEG-4 or MP4), Matroska (MKV), Hypertext Markup Language 5 (HTML 5), or any other technically feasible video format. Likewise, a machine learning model trained to predict audio data packets can be used by PPS 120 if the data packets received by PPS 120 are defined by an audio format, such as MPEG-1 Audio Layer III (MP3), waveform (WAV), advanced audio coding (AAC), or any other technically feasible audio format. In some embodiments, the machine learning model used by PPS 120 can be determined prior to receiving data packets. Predictive analytics algorithms can find patterns in previously stored data packets to make predictions about potential future data packets. In some embodiments, PPS 120 uses predictive analytics algorithms to predict future data packets based on previously stored data packets. The predictive analytics algorithms can include statistical techniques such as logistic and linear regression models, neural networks, decision trees, random forests, and/or Bayesian statistics. PPS 120 then stores the predicted packets in PPS buffer 124. PPS 120 assigns appropriate future sequence numbers to the predicted packets (e.g., the future sequence number assigned to a predicted packet corresponds to a sequence number of a next data packet in the data stream).

In some embodiments, PPS 120 uses newly received data packets to update the machine learning model or the predictive analytics algorithm. For example, when a new data packet is received that corresponds to a predicted data packet stored in PPS buffer 124 (e.g., has a same sequence number), PPS 120 can use differences between the new data packet and the corresponding previously stored predicated data packet to update the machine learning model and the predictive analytics algorithm using any suitable supervised learning technique, feedback technique, and/or any other technically feasible learning technique. For example, when PPS 120 is using a machine learning model, PPS 120 can compare the new data packet with the corresponding previously stored predicted data packet using a loss function, such as Euclidean distance and/or the like, to determine errors made in the prediction of the predicted data packet. The PPS 120 can then use the determined errors to update the machine learning model. By learning from previous predictions, PPS 120 can learn the media preferences of a user or adapt to patterns in the media content being streamed to the user. Once the new data packet is used to update the machine learning model and/or predictive analytics algorithm, the predicted data packet is no longer needed and can be overwritten by the new data packet.

PPS 120 is further configured to provide data packets to another module, such as client application 126, when the module requests a next data packet. PPS 120 is configured to detect when a next data packet is needed. In some embodiments, PPS 120 receives data packets from streaming data interface 116 in response to a request for data packets. In some embodiments, PPS 120 receives data packets from streaming data interface 116 based on a regular interval, such as 5 ms. For example, PPS 120 can receive a start instruction, or similar instruction, from client application 126, indicating to start receiving packets from streaming data interface 116 and start sending packets to client application 126 at a regular interval, such as 5 ms. PPS 120 is configured to send data packets to client application 126 based on the determining the predetermined amount of time associated with the regular interval has lapsed. For example, PPS 120 can determine that a time of 5 ms has lapsed since sending a data packet. PPS 120 can send a next data packet to client application 126 based on the lapse of 5 ms. In some embodiments, PPS 120 can store an initial group of data packets, such as 5, 10, 15, 20 or any other number of data packets, in reception buffer 122 and/or PPS buffer 124 prior to sending a first data packet to client application 126. When PPS 120 detects a next data packet is needed by client application 126, PPS 120 first checks to see whether reception buffer 122 is empty. When reception buffer 122 is not empty, PPS 120 retrieves (e.g., pops) the next data packet from reception buffer 122 and provides the next data packet to the client application 126. PPS 120 further pops the corresponding data packet from PPS buffer 124. When reception buffer 122 is empty, PPS 120 retrieves (e.g., pops) a corresponding predicted data packet from PPS buffer 124 and provides the corresponding predicted data packet to client application 126. In some embodiments, when reception buffer 122 is empty, PPS 120 retrieves (e.g., pops) a corresponding predicted data packet from PPS buffer 124 and stores (e.g., pushes) the corresponding predicted data packet to the reception buffer 122 so that the predicted data packet can be provided in response to the request from client application 126. PPS 120 determines the corresponding predicted data packet based on a unique characteristic of the corresponding predicted data packet, such as the sequence number, timestamp, presentation timestamp, and/or order of reception of the corresponding predicted data packet. For example, the corresponding predicted data packet can be a predicted data packet with a sequence number that occurs, in the sequence, directly after the sequence number of the data packet most recently provided to client application 126. In this way, even when reception buffer 122 has an underrun and does not have a received data packet to provide to client application 126, a suitable replacement (e.g., predicted) data packet is provided so that client application 126 does not run out of data packets.

Reception buffer 122 is a FIFO buffer. Reception buffer 122 can be, without limitations, a single buffer, double buffer, circular buffer, array buffer, ring buffer, vertex buffer, constant buffer, or any other technically feasible type of buffer. In some embodiments, reception buffer 122 includes a write pointer and read pointer (not shown) that references locations in the memory of reception buffer 122 where one or more data packets are stored. When a data packet is written (e.g., pushed) to reception buffer 122, the data packet is stored at a next available location. When a data packet is read (e.g., popped) from reception buffer 122 by PPS 120, reception buffer 122 retrieves the oldest data packet from memory and provides the data packet to PPS 120. When reception buffer 122 does not have a data packet that can be read, reception buffer 122 indicates that reception buffer 122 is empty.

PPS buffer 124 is a modified FIFO buffer. The modification of PPS buffer 124 allows multiple predicted data packets to be stored in PPS buffer 124. Furthermore, the modification allows incoming data packets to overwrite stored predicted data packets based on a corresponding unique characteristic, such as a sequence number, timestamp, presentation timestamp, and/or order of reception (e.g., the incoming data packet has the same sequence number as the stored predicted data packet). PPS buffer 124 can be, without limitations, a single buffer, double buffer, circular buffer, array buffer, ring buffer, vertex buffer, constant buffer, or any other technically feasible type of buffer. In some embodiments, PPS buffer 124 includes a write pointer and read pointer (not shown) that references locations in the memory of PPS buffer 124 where one or more data packets are stored. When a data packet is written (e.g., pushed) to reception buffer 122, a copy of the data packet is also stored (e.g., pushed) at a next available location that does not contain a copied data packet in PPS buffer 124. The copied data packet can overwrite a corresponding previously stored predicted data packet. PPS 120 determines the corresponding previously predicted data packet based on a unique characteristic of the corresponding predicted data packet, such as the sequence number of the corresponding predicted data packet. For example, the corresponding predicted data packet can be a predicted data packet with a sequence number that occurs, in the sequence, directly after the sequence number of any previously received data packets from streaming data interface 116. When a copy of the data packet is stored (e.g., pushed) in PPS buffer 124, a next one or more data packets are predicted by PPS 120. The one or more predicted packets are then stored (e.g., pushed) to a next available location in PPS buffer 124. When a data packet is read (e.g., popped) from PPS buffer 124 by PPS 120, PPS buffer 124 retrieves the oldest data packet from memory and provides the data packet to PPS 120. In some embodiments the oldest data packet from memory in PPS buffer 124 is a predicted data packet, which can be provided to PPS 120 in lieu of a copied data packet. When a data packet is read (e.g., popped) from reception buffer 122 by PPS 120, the corresponding data packet stored in PPS buffer 124 is removed by PPS 120. PPS 120 can determine the corresponding data packet stored in PPS buffer 124 based on the unique characteristic of the data packet read (e.g., popped) from reception buffer 122, such as a sequence number, timestamp, presentation timestamp, and/or order of reception. For example, if the sequence number of the data packet read from reception buffer 122 matches one of the sequence numbers of the one or more data packets stored in PPS buffer 124.

Client application 126 resides in memory 114 of client device 106 and executes on processor 110 of client device 106. More generally, the functionality of client application 126 can be distributed across any number of software applications. Each of the software applications can reside in any number of instances of memory 114 of any number of instances of client device 106 and execute on any number of instances of processor 110 of any number of instances of client device 106 in any combination. Client application 126 can be located in the network layer of the OSI model or internet layer of the TCP/IP model. In some embodiments, client application 126 is located in a layer of the OSI model or TCP/IP model that is above the layers in which streaming data interface 116 and PPS 120 are located. In some embodiments client application 126 is located in the same layer of the OSI model or the TCP/IP model in which PPS 120 is located. Client application 126 is configured to request, receive, and output audio and/or video data packets. Client application 126 includes client application buffer 128.

Client application 126 is configured to stream media content, such as, without limitation, a stream of audio, video, text, image, and/or animation data packets. Client application 126 is configured to detect that a next data packet is needed. In some embodiments, in response to detecting a next data packet is needed, client application 126 requests data packets from PPS 120. Client application 126 can receive data packets from PPS 120 in response to the request for data packets. In some embodiments, in response to detecting a next data packet is needed, client application 126 requests to receive data packets from PPS 120 based on a regular interval, such as 5 ms. For example, client application 126 can send a start instruction, or similar instruction, to PPS 120 indicating to start sending packets to client application 126 at a regular interval, such as 5 ms. Client application 126 can receive data packets at the regular interval after sending the start instruction. Client application 126 is configured to store incoming data packets to client application buffer 128.

Client application buffer 128 is a FIFO buffer. Client application buffer 128 can be, without limitations, a single buffer, double buffer, circular buffer, array buffer, ring buffer, vertex buffer, constant buffer, or any other technically feasible type of buffer. In some embodiments, client application buffer 128 includes a write pointer and read pointer (not shown) that references locations in the memory of client application buffer 128 where one or more data packets are stored. When a data packet is written (e.g., pushed) to client application buffer 128, the data packet is stored at a next available location. When a data packet is read (e.g., popped) from client application buffer 128 by client application 126, client application buffer 128 retrieves the oldest data packet from memory and provides the data packet to client application 126. Client application 126 displays the provided data packet as part of the audio and/or video stream.

### Buffer Underruns When Data Packets Are Encrypted

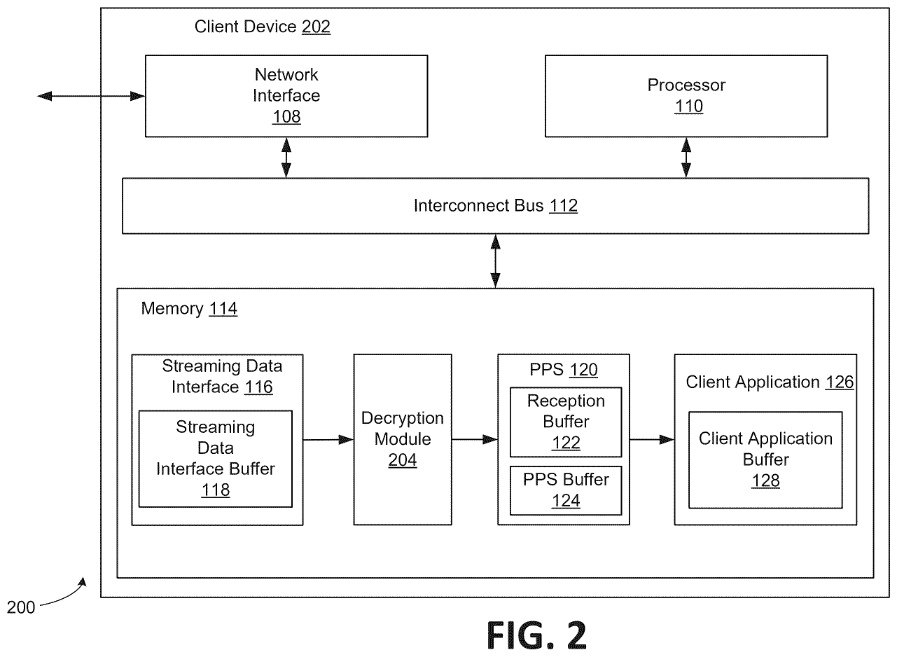

FIG. 2 illustrates a block diagram of a computer system 200 configured to implement one or more aspects of the various embodiments. As shown, system 200 includes, without limitation, a client device 202. As shown, client device 202 includes, without limitation, network interface 108, processor 110, interconnect bus 112, and memory 114. As shown, memory 114 includes, without limitation, streaming data interface 116, a decryption module 204, packet predicting system (PPS) 120, and client application 126. As shown, streaming data interface 116 includes, without limitation, streaming data interface buffer 118. As shown, PPS 120 includes, without limitation, reception buffer 122 and PPS buffer 124. As shown, client application 126 includes, without limitation, client application buffer 128.

System 200 functions similar to, albeit not identical to, system 100 of FIG. 1. System 200 can perform, without limitations, the same functions as system 100 and includes the same aspects of system 100, as well as additional aspects illustrated in FIG. 2. The following description includes, without limitation, the differences between system 200 and system 100 of FIG. 1. A person skilled in the art will understand that similar aspects of system 200 can perform the functions of the aspects in system 100 of FIG. 1, described in the system overview above.

For example, system 200 can be modified to account for receiving encrypted data packets over the network (not shown in FIG. 2), such as network 104 in FIG. 1. In some embodiments, the encrypted data packets can be associated with a media stream, such as, without limitation an audio, video, text, image, and/or animation data stream. Encrypted data packets are data packets that have been encrypted into an obfuscated format to protect the integrity and conceal the contents of the data packets from man-in-the-middle attacks or other security risks from unauthorized actors. Client device 202 in system 200 is similar to, albeit not identical to, client device 106. For example, client device 202 is configured to receive data packets that have been encrypted over the network via various network encryption methods such as Advanced Encryption Standard (AES), Data Encryption Standard (DES), Triple DES, Hypertext Transfer Protocol Secure (HTTPS), or any other technically feasible encryption method.

As described above, client device 202 is configured to include streaming data interface 116 in memory 114. Streaming data interface 116 in client device 202 is configured similarly to, albeit not identically to, streaming data interface 116 in client device 106 of FIG. 1. For example, streaming data interface 116 in client device 202 receives encrypted data packets from network interface 108 via interconnect bus 112. Streaming data interface 116 is also configured to store (e.g., push) the received encrypted data packets to a FIFO buffer, such as streaming data interface buffer 118. Streaming data interface 116 is also configured to remove (e.g., pop) the encrypted data packets from the FIFO buffer and provide the encrypted data packets to decryption module 204.

As described above, client device 202 is configured to include a decryption module 204 in memory 114. Decryption module 204 is situated between streaming data interface 116 and PPS 120. Decryption module 204 can be located in the network layer of the OSI model or internet layer of the TCP/IP model. In some embodiments, decryption module 204 is located in a layer of the OSI model or TCP/IP model that is above the layer in which streaming data interface 116 is located. In some embodiments decryption module 204 is located in the same layers of the OSI model or TCP/IP model in which PPS 120 and client application 126 is located. Decryption module 204 is configured to decrypt encrypted data packets. Decryption module 204 can receive encrypted data packets from streaming data interface 116. Decryption module 204 can decrypt the received encrypted data packets and send the decrypted data packets to PPS 120. Decryption module 204 can decrypt the encrypted data packets according to any technically feasible decryption method based on the encryption methods described above.

As described above, client device 202 is configured to include PPS 120 in memory 114. PPS 120 in client device 202 is configured similarly to, albeit not identically to, PPS 120 in client device 106 of FIG. 1. For example, PPS 120 in client device 202 is configured to receive decrypted data packets from decryption module 204. PPS 120 can be located in the network layer of the OSI model or internet layer of the TCP/IP model. In some embodiments, PPS 120 is located in a layer of the OSI model or TCP/IP model that is above the layer in which streaming data interface 116 is located. In some embodiments PPS 120 is located in the same layers of the OSI model or TCP/IP model in which decryption modules 204 and client application 126 is located. PPS 120 needs to receive decrypted data packets in order to properly predict future data packets in substantially the same manner as described above with respect to FIG. 1.

As described above, client device 202 is configured to include client application 126 in memory 114. client application 126 in client device 202 is configured substantially similarly to client application 126 in client device 106 of FIG. 1. For example, client application 126 in client device 202 is configured to receive decrypted data packets from PPS 120. Client application 126 can be located in the network layer of the OSI model or internet layer of the TCP/IP model. In some embodiments, client application 126 is located in a layer of the OSI model or TCP/IP model that is above the layer in which streaming data interface 116 is located. In some embodiments client application 126 is located in the same layers of the OSI model or TCP/IP model in which decryption modules 204 and PPS 120 are located.

### Snapshots in Time of the Contents of the Buffers

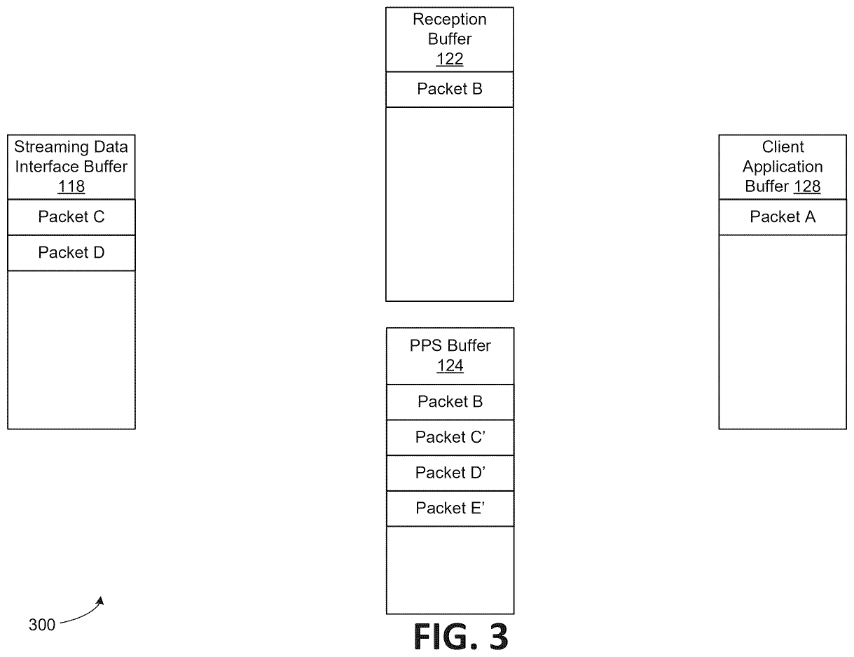

FIG. 3 is a conceptual illustration of an exemplary snapshot 300 in time of various buffers and the contents of the various buffers, according to various embodiments. As shown, snapshot 300 includes streaming data interface buffer 118, reception buffer 122, PPS buffer 124, and client application buffer 128 of system 100 and/or 200, and the contents of each buffer. Snapshot 300 represents an example snapshot of time in which a client application, such as client application 126 of system 100 has detected a next data packet is needed. Client application 126 is configured to stream media content, such as a stream of audio, video, text, image, and/or animation data packets. Client application 126 is configured to detect that a next data packet is needed. In some embodiments, in response to detecting a next data packet is needed, client application 126 requests data packets from PPS 120. Client application 126 can receive data packets from PPS 120 in response to the request for data packets. In some embodiments, in response to detecting a next data packet is needed, client application 126 requests to receive data packets from PPS 120 based on a regular interval, such as 5 ms. For example, client application 126 can send a start instruction, or similar instruction, to PPS 120 indicating to start sending packets to client application 126 at a regular interval, such as 5 ms. Client application 126 can receive data packets at the regular interval after sending the start instruction. In response to the request from client application 126, streaming data interface buffer 118 started receiving data packets via a network, such as network 104 in FIG. 1. For example, streaming data interface buffer 118 can receive Packets A, B, C, and D.

At snapshot 300, Packets A and B have already been popped from streaming data interface buffer 118, but streaming data interface buffer 118 still contains Packets C and D. At snapshot 300, Packet A has already been popped from reception buffer 122. At snapshot 300, Packet B has been pushed to reception buffer 122. At snapshot 300, Packet A has also been popped from PPS buffer 124 and a copy of Packet B has also been pushed to PPS buffer 124. In snapshot 300, Packets C′, D′, and E′, as predicted by PPS 120, have also been stored in PPS buffer 124. At snapshot 300, client application 126 in FIG. 1, which includes client application buffer 128, has received Packet A from PPS 120 and pushed Packet A to client application buffer 128.

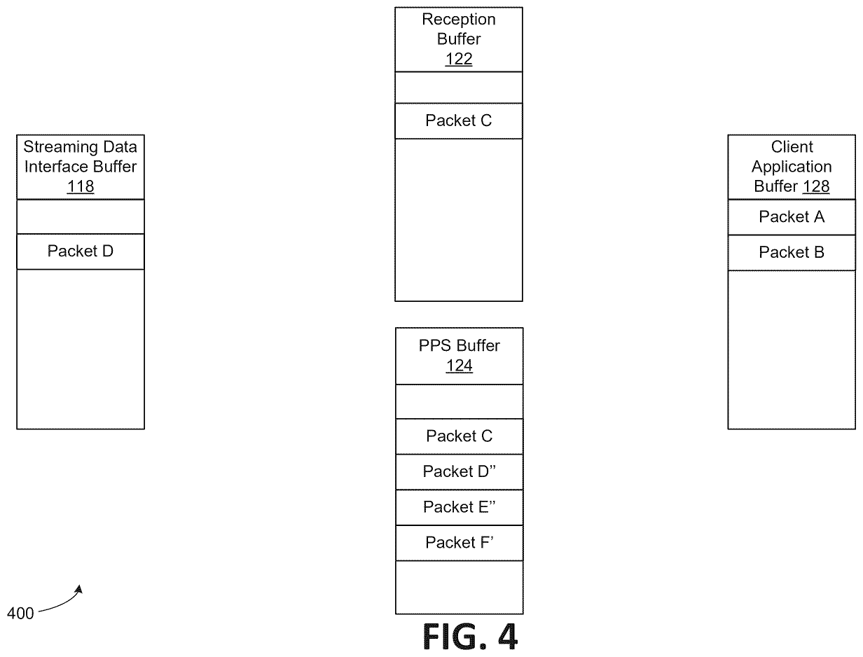

FIG. 4 is another conceptual illustration of another exemplary snapshot 400 in time of various buffers and the contents of the various buffers, according to various embodiments. As shown, snapshot 400 includes streaming data interface buffer 118, reception buffer 122, PPS buffer 124, and client application buffer 128 of system 100 and/or 200, and the contents of each buffer. Snapshot 400 represents an example snapshot of time after snapshot 300.

At snapshot 400, client application 126 has detected an additional data packet is needed. As a result, either based on a regular interval or in response to a request for the next data packet, Packet B has been popped from reception buffer 122 and PPS buffer 124, and Packet B has been pushed to client application buffer 128. Snapshot 400 also shows that PPS 120 has requested an additional data packet (e.g., Packet C) from streaming data interface 116. As a result, Packet C has been popped from streaming data interface 116, and Packet C has been pushed to reception buffer 122. At snapshot 400, a copy of Packet C has also been pushed to PPS buffer 124, overwriting predicted Packet C′. Predicted Packet C′ has been overwritten based on a unique characteristic, such as a sequence number, of Packet C matching a corresponding unique characteristic, such as a corresponding sequence number, of predicted Packet C′. As a result, PPS 120 retrained or updated the machine learning model based on the differences between Packet C and predicted Packet C′. At snapshot 400, PPS 120 used the retrained or updated machine learning model to generate more predicted data packets (e.g., predicted Packets D″, E″, and F′). As a result, predicted Packets D″, E″, and F′ have been pushed to PPS buffer 124. Predicted packets D″ and E″ have overwritten predicted packets D′ and E′ because the newly predicted data packets represent predictions based on updated data.

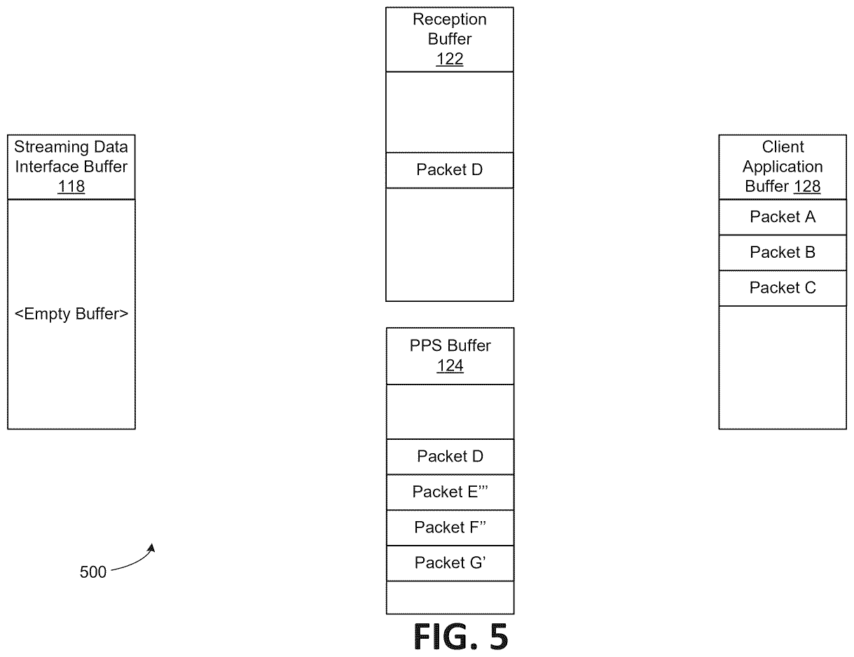

FIG. 5 is another conceptual illustration of another exemplary snapshot 500 in time of various buffers and the contents of the various buffers, according to various embodiments. As shown, snapshot 500 includes streaming data interface buffer 118, reception buffer 122, PPS buffer 124, and client application buffer 128 of system 100 and/or 200, and the contents of each buffer. Snapshot 500 represents an example snapshot of time after snapshot 400.

At snapshot 500, client application 126 has detected an additional data packet is needed. As a result, either based on a regular interval or in response to a request for the next data packet, Packet C has been popped from reception buffer 122 and PPS buffer 124, and Packet C has been pushed to client application buffer 128. Snapshot 500 also shows that PPS 120 has requested an additional data packet (e.g., Packet D) from streaming data interface 116. As a result, Packet D has been popped from streaming data interface 116, and Packet D has been pushed to reception buffer 122. At snapshot 500, a copy of Packet D has also been pushed to PPS buffer 124, overwriting predicted Packet D″. Predicted Packet D″ has been overwritten based on a unique characteristic, such as a sequence number, of Packet D matching a corresponding unique characteristic, such as a corresponding sequence number, of predicted Packet D″. As a result, PPS 120 retrained or updated the machine learning model based on the differences between Packet D and predicted Packet D″. At snapshot 500, PPS 120 used the retrained or updated machine learning model to generate more predicted data packets (e.g., predicted Packets E″′, F″, and G′). As a result, predicted Packets E″′, F″, and G′ have been pushed to PPS buffer 124. Predicted packets E″′ and F″ have overwritten predicted packets E″ and F′ because the newly predicted data packets represent predictions based on updated data.

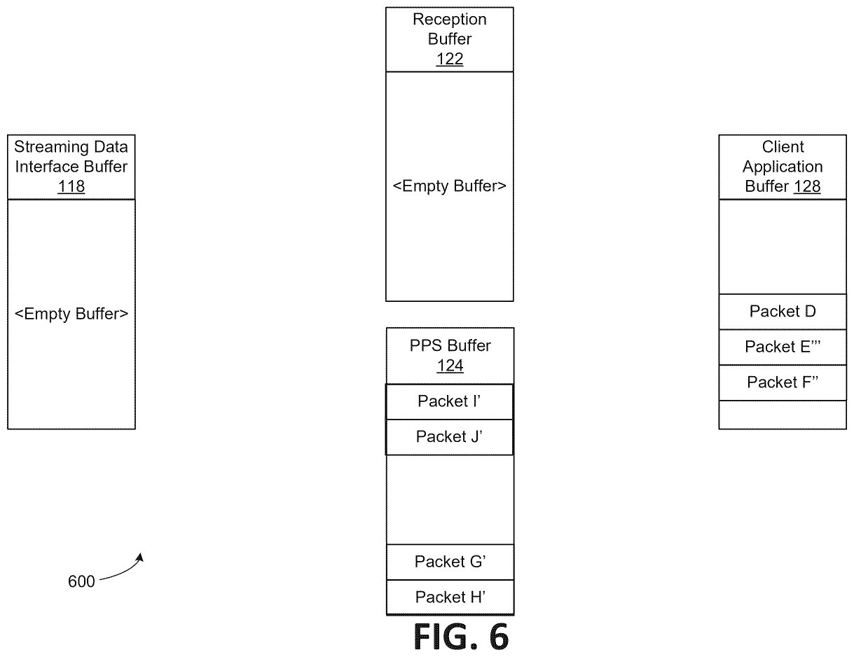

FIG. 6 is another conceptual illustration of another exemplary snapshot 600 in time of various buffers and the contents of the various buffers, according to various embodiments. As shown, snapshot 600 includes streaming data interface buffer 118, reception buffer 122, PPS buffer 124, and client application buffer 128 of system 100 and/or 200, and the contents of each buffer. Snapshot 600 represents an example snapshot of time after snapshot 500, when streaming data interface buffer 118 has incurred a buffer underrun and is no longer receiving data packets over the network.

At snapshot 600, PPS 120 has received an indication that streaming data interface buffer 118 has been empty for an amount of time. At snapshot 600, reception buffer 122 has also been empty for an amount of time. As a result, predicted Packet F″ has been popped from PPS buffer 124, and predicted packet F″ has been pushed to client application buffer 128. At snapshot 600, PPS 120 used the machine learning model to generate more predicted data packets (e.g., predicted Packets G′, H′, I′, and J′).

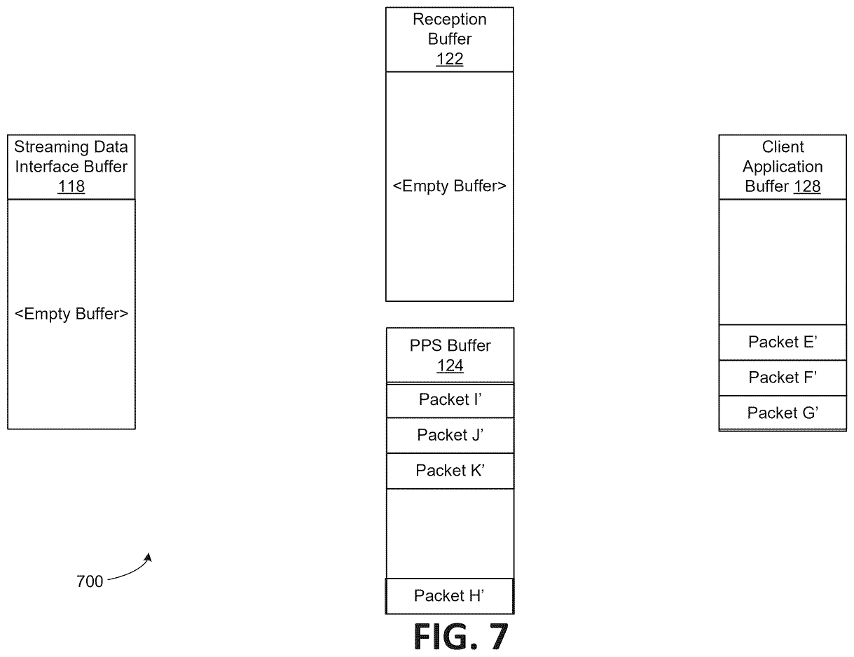

FIG. 7 is another conceptual illustration of another exemplary snapshot 700 in time of various buffers and the contents of the various buffers, according to various embodiments. As shown, snapshot 700 includes streaming data interface buffer 118, reception buffer 122, PPS buffer 124, and client application buffer 128 of system 100 and/or, and the contents of each buffer. Snapshot 700 represents an example snapshot of time after snapshot 600, while streaming data interface buffer 118 is still incurring a buffer underrun.

At snapshot 700, PPS 120 has received an indication that streaming data interface buffer 118 has been empty for an amount of time. At snapshot 700, reception buffer 122 has also been empty for an amount of time. As a result, predicted Packet G′ has been popped from PPS buffer 124, and predicted packet G′ has been pushed to client application buffer 128. At snapshot 700, PPS 120 used the machine learning model to generate more predicted data packets (e.g., predicted Packets H′, I′, J′, and K′).

In some embodiments, streaming data interface 116 can receive new data packets after incurring the buffer underrun. For example, streaming data interface 116 can receive new packet X (not shown). New packet X is treated similar to Packet B in Snapshot 300 of FIG. 3.

### Method of Compensating for Buffer Underruns

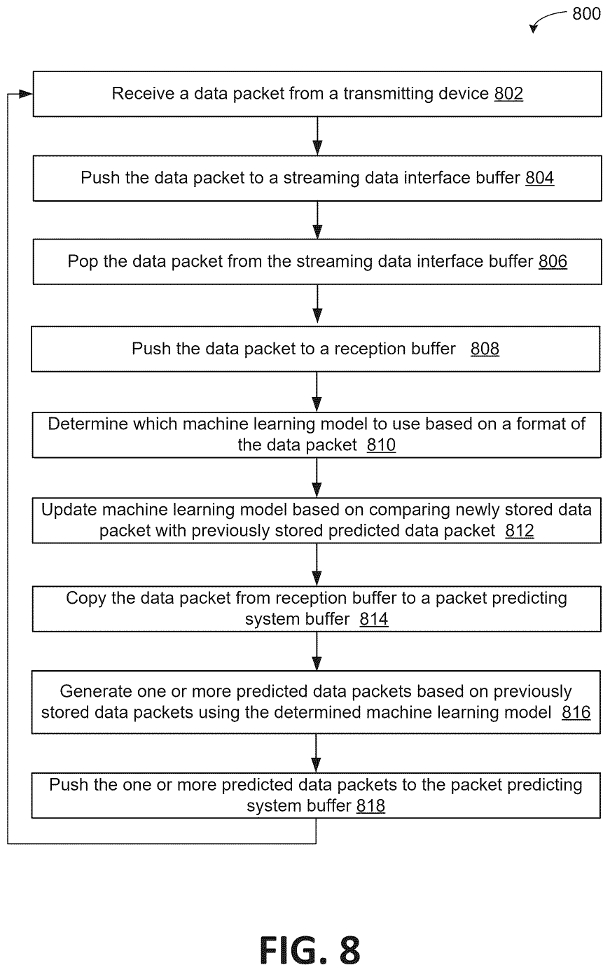

FIG. 8 sets forth a flow diagram of method steps for compensating for buffer underruns by predicting missing media content. Although the method steps are described with reference to the systems of FIGS. 1-7, persons skilled in the art will understand that any system configured to implement the method steps, in any order, falls within the scope of the present invention.

As shown, a method 800 begins at step 802, where client device 106 in FIG. 1 receives a data packet from a transmitting device, such as server device 102 in FIG. 1, via a network, such as network 104 in FIG. 1. Client application 126 of client device 106 is configured to stream media content, such as a stream of audio, video, text, image, and/or animation data packets. Client application 126 is configured to detect that a next data packet is needed. In some embodiments, in response to detecting a next data packet is needed, client application 126 requests data packets from PPS 120. Client application 126 can receive data packets from PPS 120 in response to the request for data packets. In some embodiments, in response to detecting a next data packet is needed, client application 126 requests to receive data packets from PPS 120 based on a regular interval, such as 5 ms. For example, client application 126 can send a start instruction, or similar instruction, to PPS 120 indicating to start sending packets to client application 126 at a regular interval, such as 5 ms. Client application 126 can receive data packets at the regular interval after sending the start instruction.

At step 804, either based on a regular interval or in response to a request for the next data packet, streaming data interface 116 of client device 106 pushes the data packet to streaming data interface buffer 118. For example, Packet C and D were pushed to streaming data interface buffer 118 prior to snapshot 300.

At step 806, streaming data interface 116 pops the data packet from streaming data interface buffer 118. Popping the data packet can be based on a regular interval or in response to a request for the data packet from PPS 120. For example, Packet C was popped from streaming data interface buffer 118 between snapshots 300 and 400.

At step 808 PPS 120 pushes the data packet to reception buffer 122. For example, Packet C was pushed to reception buffer 122 between snapshots 300 and 400.

At step 810, PPS 120 determines a machine learning model to use based on a format of the data packet pushed to reception buffer 122. For example, if the format of the data packet is MP4, PPS 120 can determine to use a machine learning model that can predict future video data packets. PPS 120 can switch to a different machine learning model if a previously selected machine learning model does not match the format of the newly stored data packet.

At step 812, PPS 120 updates the machine learning model based on comparing the newly pushed data packet in the reception buffer with previously stored predicted data packets. For example, when a new data packet is received that corresponds to a predicted data packet pushed in reception buffer 122 (e.g., has a same sequence number), PPS 120 can use differences between the new data packet and the corresponding previously stored predicated data packet to update the machine learning model and the predictive analytics algorithm using any suitable supervised learning technique, feedback technique, and/or any other technically feasible learning technique. For example, when PPS 120 is using a machine learning model, PPS 120 can compare the new data packet with the corresponding previously stored predicted data packet using a loss function, such as Euclidean distance and/or the like, to determine errors made in the prediction of the predicted data packet. The PPS 120 can then use the determined errors to update the machine learning model. By learning from previous predictions, PPS 120 can learn the media preferences of a user or adapt to patterns in the media content being streamed to the user. Once the new data packet is used to update the machine learning model and/or predictive analytics algorithm, the predicted data packet is no longer needed and can be overwritten by the new data packet.

At step 814, PPS 120 copies the data packet pushed to reception buffer 122 to PPS buffer 124. For example, a copy of Packet C is pushed to PPS buffer 124 between snapshots 300 and 400. Additionally, the copy of the packet pushed to PPS buffer 124 can overwrite a previously predicted packet based on the copied packet having a unique characteristic, such as a sequence number, that matches a corresponding unique characteristic, such as a corresponding sequence number, of the previously predicted packet.

At step 816, PPS 120 generates one or more predicted data packets based on previously stored data packets using the determined machine learning model of PPS 120. For example, predicted Packets F′ was generated by PPS 120 between snapshots 300 and 400. Additionally, PPS 120 can generate one or more predicted data packets that overwrite previously predicted packets using the determined machine learning model of PPS 120. For example, previously predicted packets E″ and F′ were overwritten during snapshot 400 and 500 because the newly predicted data packets represent predictions based on updated data.

At step 818, PPS 120 pushes the one or more predicted data packets to PPS buffer 124. For example, predicted Packet F′ was pushed to PPS buffer 124 between snapshots 300 and 400. PPS 120 can pop the one or more predicted data packets when reception buffer 122 and/or streaming data interface buffer 118 incur a buffer underrun. After step 818, the method 800 can iterate back to step 802.

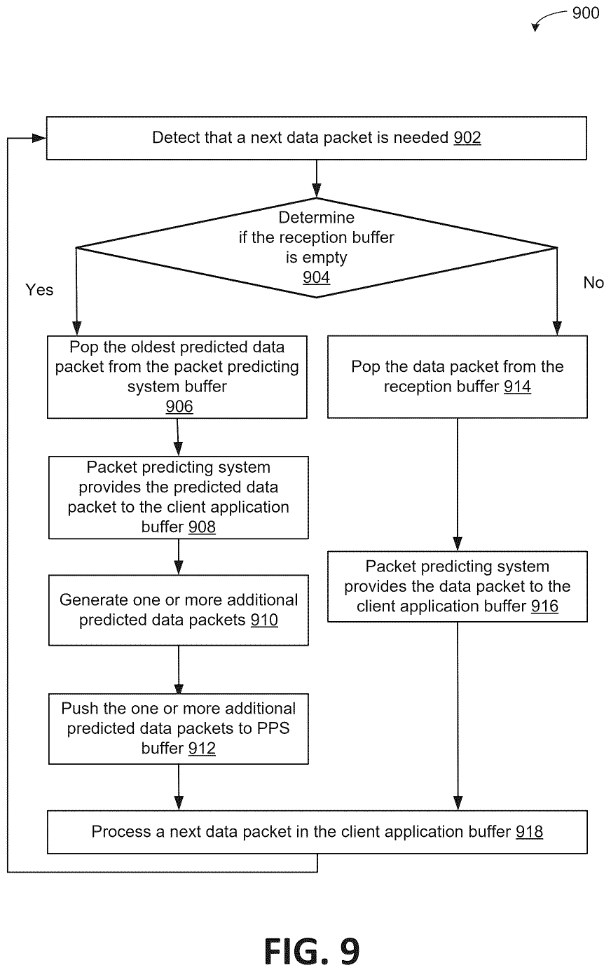

FIG. 9 sets forth another flow diagram of method steps for compensating for buffer underruns by predicting missing media content data. Although the method steps are described with reference to the systems of FIGS. 1-7, persons skilled in the art will understand that any system configured to implement the method steps, in any order, falls within the scope of the present invention.

As shown, a method 900 begins at step 902, where PPS 120 of client device 106 detects a next data packet is needed. PPS 120 is configured to detect that a next data packet is needed by client application 126. In some embodiments, PPS 120 detects that a next data packet is needed when client application 126 sends a request to PPS 120 for a next data packet. In some embodiments, PPS 120 detects that a next packet is needed at regular time intervals, such as when a time expires.

At step 904, PPS 120 determines if reception buffer 122 is empty. PPS 120 can determine if streaming data interface buffer 118 is empty by receiving an indication from reception buffer 122 that reception buffer 122 is empty. If reception buffer 122 is empty, a buffer underrun has occurred. For example, this is depicted in snapshot 600 when client application 126 has requested both Packets E and F, but these packets were not available in reception buffer 122.

If at step 904, reception buffer 122 is empty, method 900 continues to step 906. At step 906, PPS 120 pops the oldest predicted data packet from PPS buffer 124. For example, both predicted Packets E′ and F′ were popped from PPS buffer 124 before snapshot 600 and predicted Packet G′ is popped from PPS buffer 124 between snapshots 600 and 700. The oldest predicted data packet can be determined based on comparing one or more unique characteristics of the predicted data packets, such as a sequence number, timestamp, presentation timestamp, and/or reception order, stored in PPS buffer 124 to identify the oldest or to identify the predicted data packet corresponding to the request from client application 126.

At step 908, PPS 120 provides the predicted data packet to client application 126. Client application 126 then pushes the predicted data packet to client application buffer 128. For example, predicted Packet G′ is pushed to client application buffer 128 as shown in snapshot 700.

At step 910, PPS 120 generates one or more additional predicted data packets to replace the predicted data packet that was recently popped from PPS buffer 124. For example, after Packet G′ was popped from PPS buffer 124 between snapshot 600 and 700, PPS 120 generated Packet K′.

At step 912, the one or more additional predicted data packets are pushed to PPS buffer 124. For example, after Packet K′ was generated between snapshots 600 and 700, PPS 120 pushed Packet K′ to PPS buffer 124. After step 912, method 900 continues to step 918.

If at step 904, reception buffer 122 is not empty, method 900 continues to step 914. At step 914, PPS 120 pops the next available data packet from reception buffer 122. For example, Packet B is popped from reception buffer 122 between snapshots 300 and 400 and packet C is popped from reception buffer 122 between snapshots 400 and 500. Additionally, PPS 120 pops the next available data packet from PPS buffer 124, as it is no longer needed. For example, Packet B is popped from PPS buffer 124 between snapshots 300 and 400 and Packet C is popped from PPS buffer 124 between snapshots 400 and 500.

At step 916, PPS 120 provides the data packet to client application 126. Client application 126 then pushes the data packet to client application buffer 128. For example, Packet C is pushed to client application buffer 128 as shown in snapshot 500. After step 916, method 900 continues directly to step 918.

At step 918, client application 126 processes the next available data packet stored in client application buffer 128. For example, client application 126 can process any of Packets A, B, C, D, E′, F′, and/or G′ after the packets are pushed to client application buffer 128. In some embodiments, client application 126 processes the data packets by streaming the data packets to one or more users. After step 918, method 900 can iterate back to step 902.

In sum, the disclosed techniques compensate for buffer underruns by predicting missing media content, such as, without limitation, audio, video, text, image, and/or animation data. During playback of a stream of media content, the network interface of the client device receives media content data packets from a server device. The streaming data interface includes a first buffer to store the packets temporarily while being moved from the network interface to the streaming data interface of the client device. The packet predicting system includes two more buffers. The second buffer, located in the packet predicting system, is a buffer that temporarily stores packets received from the streaming data interface while being moved from the packet predicting system to the client application. The third buffer, also in the packet predicting system, is a buffer that stores copies of packets stored in the second buffer. In addition, the packet predicting system predicts a predetermined number of future packets each time it copies new packets to the third buffer. The predicted packets are stored in the third buffer. When the client application needs a next packet, the packet predicting system of the receiving device provides the next packet from the second buffer to the client application. However, when the second buffer is empty, the packet predicting system provides a predicted packet from the third buffer to the client application. In addition, the packet predicting system compares newly received packets to predicted packets to improve the prediction of future packets.

At least one technical advantage of the disclosed techniques relative to the prior art is that the disclosed techniques allow for the receiving device to automatically correct for buffer underruns by using corrective measures solely at the receiving device. This reduces the computational burden on the transmitting device to perform additional processes, such as rate control or flow control. In addition, this reduces network bandwidth as rate control and flow control messages do not need to be exchanged between the receiving and transmitting devices. Furthermore, the disclosed techniques predict missing data packets before the receiving device misses one or more data packets due to a buffer underrun, or other network congestion. These technical advantages provide one or more technological improvements over prior art approaches.
1. In some embodiments, a computer-implemented method for handling media data comprises receiving a first data packet from a streaming data interface, the first data packet including media data; storing the first data packet to a first buffer; storing the first data packet to a second buffer; generating, based on one or more data packets stored in the second buffer, a first predicted data packet; storing, in the second buffer, the first predicted data packet; and in response to determining that a second data should be provided, providing the second data packet from the first buffer or the second buffer, wherein the second data packet is usable by a client application as output streamed to a user.
2. The computer-implemented method of clause 1, wherein determining that the second data packet should be provided comprises receiving a request from the client application or determining a predetermined amount of time has lapsed.
3. The computer-implemented method of any of clauses 1-2, wherein providing the second data packet from the first buffer or the second buffer comprises: determining that the first buffer is empty; and providing a first stored predicted packet from the second buffer in response to the request.
4. The computer-implemented method of any of clauses 1-3, wherein the first data packet is received by the streaming data interface from a network.
5. The computer-implemented method of any of clauses 1-4, wherein the second data packet is provided to the client application when the first buffer is underrun.
6. The computer-implemented method of any of clauses 1-5, further comprising: wherein providing the second data packet from the first buffer or the second buffer comprises: determining that the first buffer contains at least one data packet; and providing a first stored packet from the first buffer in response to the request.
7. The computer-implemented method of any of clauses 1-6, wherein generating the first predicted data packet comprises using a machine learning model.
8. The computer-implemented method of clause 7, further comprising selecting the machine learning model from a plurality of machine learning models based on a type of media data in the first data packet.
9. The computer-implemented method of any of clauses 7-8, further comprising: retraining the machine learning model based on the first data packet and a corresponding predicted packet stored in the second buffer, wherein storing the first data packet in the second buffer comprises replacing the corresponding predicted packet.
10. The computer-implemented method of clause 9, wherein the corresponding predicted packet has a same unique characteristic as the first data packet.
11. The computer-implemented method of clause 8, wherein generating the first predicted data packet comprises using one or more predictive analytics algorithms.
12. The computer-implemented method of any of clauses 1-11, wherein the first data packet is decrypted before storing the first data packet in the first buffer.
13. In some embodiments, one or more non-transitory computer-readable media including instructions that, when executed by one or more processors, cause the one or more processors to perform the steps of: receiving a first data packet from a streaming data interface, the first data packet including media data; storing the first data packet to a first buffer; storing the first data packet to a second buffer; generating, based on one or more data packets stored in the second buffer, a first predicted data packet; storing, in the second buffer, the first predicted data packet; and in response to determining that a second data packet should be provided, providing the second data packet from the first buffer or the second buffer, wherein the second data packet is usable by the client application as output streamed to a user.
14. The one or more non-transitory computer-readable media of clause 13, wherein the step of providing the second data packet from the first buffer or the second buffer comprises: determining that the first buffer is empty; and providing a first stored predicted packet from the second buffer in response to the request.
15. The one or more non-transitory computer-readable media of any of clauses 13-14, wherein the first data packet is received by the streaming data interface from a network.
16. The one or more non-transitory computer-readable media of any of clauses 13-15, wherein the second data packet is provided to the client application when the first buffer is underrun.
17. The one or more non-transitory computer-readable media of any of clauses 13-16, wherein the step of generating the first predicted data packet comprises using a machine learning model.
18. The one or more non-transitory computer-readable media of clause 17, wherein the steps further comprise selecting the machine learning model from a plurality of machine learning models based on a type of media data in the first data packet.
19. The one or more non-transitory computer-readable media of any of clauses 17-18, wherein the steps further comprise: retraining the machine learning model based on the first data packet and a corresponding predicted packet stored in the second buffer; and wherein storing the first data packet in the second buffer comprises replacing the corresponding predicted packet.
20. In some embodiments, a client device for handling media data comprises: a streaming data interface, a first buffer, a second buffer, one or more memories storing a client application; and one or more processors coupled to the one or more memories that, when executing the client application, perform the steps of: receiving a first data packet from the streaming data interface, the first data packet including media data; storing the first data packet to the first buffer; storing the first data packet to the second buffer; generating, based on one or more data packets stored in the second buffer, a first predicted data packet; storing, in the second buffer, the first predicted data packet; and in response to determining that a second data packet should be provided, providing the second data packet from the first buffer or the second buffer, wherein the second data packet is usable by the client application as output streamed to a user.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for handling media data, the method comprising:
receiving a first data packet from a streaming data interface, the first data packet including media data;
storing the first data packet to a first buffer;
storing the first data packet to a second buffer;
generating, based on one or more data packets stored in the second buffer, a first predicted data packet;
storing, in the second buffer, the first predicted data packet; and
in response to determining that a second data should be provided, providing the second data packet from the first buffer or the second buffer, wherein the second data packet is usable by a client application as output streamed to a user.

2. The method of claim 1, wherein determining that the second data packet should be provided comprises receiving a request from the client application or determining a predetermined amount of time has lapsed.

3. The method of claim 1, wherein providing the second data packet from the first buffer or the second buffer comprises:
determining that the first buffer is empty; and
providing a first stored predicted packet from the second buffer in response to the request.

4. The method of claim 1, wherein the first data packet is received by the streaming data interface from a network.

5. The method of claim 1, wherein the second data packet is provided to the client application when the first buffer is underrun.

6. The method of claim 1, further comprising:
wherein providing the second data packet from the first buffer or the second buffer comprises:
determining that the first buffer contains at least one data packet; and
providing a first stored packet from the first buffer in response to the request.

7. The method of claim 1, wherein generating the first predicted data packet comprises using a machine learning model.

8. The method of claim 7, further comprising selecting the machine learning model from a plurality of machine learning models based on a type of media data in the first data packet.

9. The method of claim 7, further comprising:
retraining the machine learning model based on the first data packet and a corresponding predicted packet stored in the second buffer,
wherein storing the first data packet in the second buffer comprises replacing the corresponding predicted packet.

10. The method of claim 9, wherein the corresponding predicted packet has a same unique characteristic as the first data packet.

11. The method of claim 8, wherein generating the first predicted data packet comprises using one or more predictive analytics algorithms.

12. The method of claim 1, wherein the first data packet is decrypted before storing the first data packet in the first buffer.

13. One or more non-transitory computer-readable media including instructions that, when executed by one or more processors, cause the one or more processors to perform the steps of:
receiving a first data packet from a streaming data interface, the first data packet including media data;
storing the first data packet to a first buffer;
storing the first data packet to a second buffer;
generating, based on one or more data packets stored in the second buffer, a first predicted data packet;
storing, in the second buffer, the first predicted data packet; and
in response to determining that a second data packet should be provided, providing the second data packet from the first buffer or the second buffer, wherein the second data packet is usable by the client application as output streamed to a user.

14. The one or more non-transitory computer-readable media of claim 13, wherein the step of providing the second data packet from the first buffer or the second buffer comprises:
determining that the first buffer is empty; and
providing a first stored predicted packet from the second buffer in response to the request.

15. The one or more non-transitory computer-readable media of claim 13, wherein the first data packet is received by the streaming data interface from a network.

16. The one or more non-transitory computer-readable media of claim 13, wherein the second data packet is provided to the client application when the first buffer is underrun.

17. The one or more non-transitory computer-readable media of claim 13, wherein the step of generating the first predicted data packet comprises using a machine learning model.

18. The one or more non-transitory computer-readable media of claim 17, wherein the steps further comprise selecting the machine learning model from a plurality of machine learning models based on a type of media data in the first data packet.

19. The one or more non-transitory computer-readable media of claim 17, wherein the steps further comprise:
retraining the machine learning model based on the first data packet and a corresponding predicted packet stored in the second buffer; and
wherein storing the first data packet in the second buffer comprises replacing the corresponding predicted packet.

20. A client device for handling media data comprising:
a streaming data interface,
a first buffer,
a second buffer,
one or more memories storing a client application; and
one or more processors coupled to the one or more memories that, when executing the
client application, perform the steps of:
receiving a first data packet from the streaming data interface, the first data packet including media data;
storing the first data packet to the first buffer;
storing the first data packet to the second buffer;
generating, based on one or more data packets stored in the second buffer, a first predicted data packet;
storing, in the second buffer, the first predicted data packet; and
in response to determining that a second data packet should be provided, providing the second data packet from the first buffer or the second buffer, wherein the second data packet is usable by the client application as output streamed to a user.
